(19) United States
(12) Patent Application Publication
(10) Pub. No.: US 2005/0241755 A1
(43) Pub. Date: Nov. 3, 2005

(54) Device for forming a glue profile for cross-base sacks

(76) Inventors: Marco Daher, Wallenhorst (DE); Ruediger Duwendag, Lengerich (DE); Guido Kerres, Muenster (DE)

Correspondence Address: JACOBSON HOLMAN PLLC, 400 SEVENTH STREET N.W., SUITE 600, WASHINGTON, DC, 20004, US

(21) Appl. No.: 10/524,264

(22) PCT Filed: Sep. 2, 2003
(86) PCT No.: PCT/EP03/09791

§ 371 Date: Feb. 11, 2005

(30) Foreign Application Priority Data
Sep. 13, 2002 (DE) 102-42-539.6

(51) Int. Cl. B05C 11/10

(52) U.S. Cl. 156/291; 156/548; 118/684; 118/313

(57) ABSTRACT

An apparatus (30, 100, 200) is presented for forming a glue profile for gluing the bottom sheets (2) and/or folded bottoms (1) of tube portions which (1, 2) [sic] are used for forming block bottom bags (19).

The device (30,100,200) comprises the following features:
at least one first glue reservoir (101) or at least one glue input (111a,b) from which glue is supplied,
glue lines (110) which transport glue to the gluing locations,
a number of glue valves (32) which are to open and close individually, the glue profile (4) being definable based on the selective opening of the valves (32);
glue outputs (71) which are allocated to the valves (32);
at least one second glue reservoir (102), by means of which the second glue reservoir (102) can be pressurized.

Methods for forming a glue profile (4) are also laid out.

The invention relates to an apparatus for forming a glue profile for gluing the bottom sheets and/or folded bottoms of tube portions that are used for forming block-bottom bags.

In other technical fields, an apparatus for forming a glue profile for gluing bag components is already known. The bag components are then used for forming bags. DE 199 35 117 suggests one such apparatus for forming glue profiles of bags. It comprises the following features:
a plurality of glue valves which open and close individually, the glue profile being definable through the selective opening of the valves;
a glue line which is connected to the valves;
glue outputs which are allocated to the valves.

DE 199 35 117 describes a device in which the glue first reaches valves via a glue line and is then extruded onto a drum through the glue outputs thereof. The drum transfers the glue onto the bag components. But neither DE 199 35 117 nor any other publication suggests forming block-bottom bags with the aid of such an apparatus. In order to understand this fact, the knowledge of the manufacturing processes of various bag types is important. In this regard, one should emphasize the differences between pinch bottom bags and block bottom bags. The forming of block bottom bags is laid out in De 090 145 48 U1 and De 3020043 A1 for example. In the gluing of the bottom sheets and folded bottoms, very large amounts of glue that is difficult to convey must be distributed over a large format width.

Besides this, the application of the glue profile is usually intermittent; that is, specific regions are glued into the individual form of the desired bag components. Glue application does not occur in the spaces between.

In the case of block bottom bags, either the folded bottom or the bottom sheets attached to them or both of the previously named elements to be glued are to be covered with a sheet of glue and in the end are brought together.

According to the prior art, the gluing of the components of the bag occurs by means of a blank—often referred to as a stereotype—which is fastened to a rotating drum being brought into contact with glue drums or other glue storage or transfer parts as the drum turns, and is thereby charged with glue. Later in the drum rotation, the format plate transfers the glue stored therein onto the bag component.

To that end, the blank is provided with characteristic elevations, which are adjusted to a particular bag format. The blanks are swapped out if bags with other dimensions are to be produced on the bottom laying apparatus.

The described method of glue application has proven useful in bottom laying apparatuses for paper bags, because large amounts of difficult-to-handle starch glue can be applied cleanly that way.

However, the disadvantages of these device include the need to exchange blanks with each format change. Glue formats of valve arrays—i.e. configurations of glue valves at a gluing station—can be extruded in order to obviate the need for blanks. But first it is necessary to overcome the difficulties which glue application poses for the valves.

This object is achieved by an apparatus comprising the following features:
at least one first glue reservoir or at least one glue input from which the glue is conducted;
glue lines which transport glue to the gluing locations;
a plurality of glue valves which open and close individually, the glue profile being definable by the selective opening and closing of the valves;
glue outputs which are allocated to the valves;
at least one second glue reservoir, which his charged with an overpressure and connected to at least two valves;
a pressure reservoir by means of which the second glue reservoir can be charged with pressure.

In an inventive apparatus, it is possible to conduct glue from a glue mixing apparatus or glue container to the gluing locations. At the gluing locations, a plurality of valves forms the glue profile, which is either extruded onto the bag components directly after leaving the glue outputs or transferred to a transfer element like a drum according to DE 199 35 117 first and then transferred onto the bag components.

The setting of different glue profiles is achieved by the selective opening of the valves. The glue supply of at least two valves is achieved by means of a common glue reservoir in which glue is stored and/or through which the glue can be conducted. Besides saving expensive glue line components, this measure ensures that the valves are charged with the same or similar pressure, and, as a result, identical or similar glue trails are extruded.

This glue reservoir corresponds with a pressure reservoir which can compensate or at least cushion pressure fluctuations in the second glue reservoir, potentially in a fraction of a second.

There are many possibilities for realizing such a pressure reservoir. An advantageous embodiment of the invention provides a pressure reservoir which contains a compressible medium which is under pressure.

Another possibility is to provide at least a third glue reservoir in which the glue is under a higher pressure than in the second glue reservoir.

Further exemplifying embodiments of the invention emerge from the present description and claims.

The figures show:

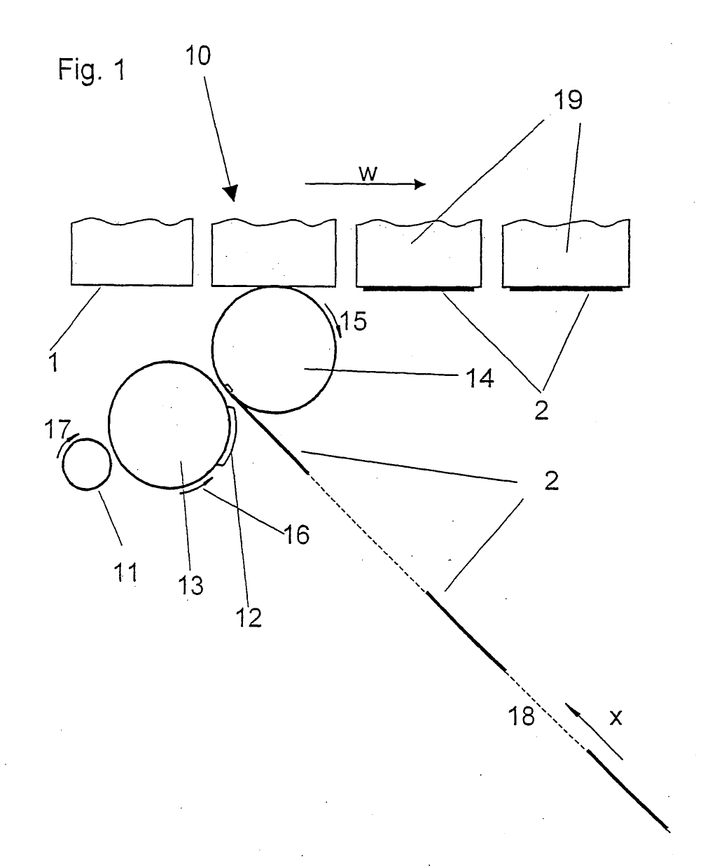

FIG. 1 a glue application apparatus for bag bottom sheets according to the prior art;

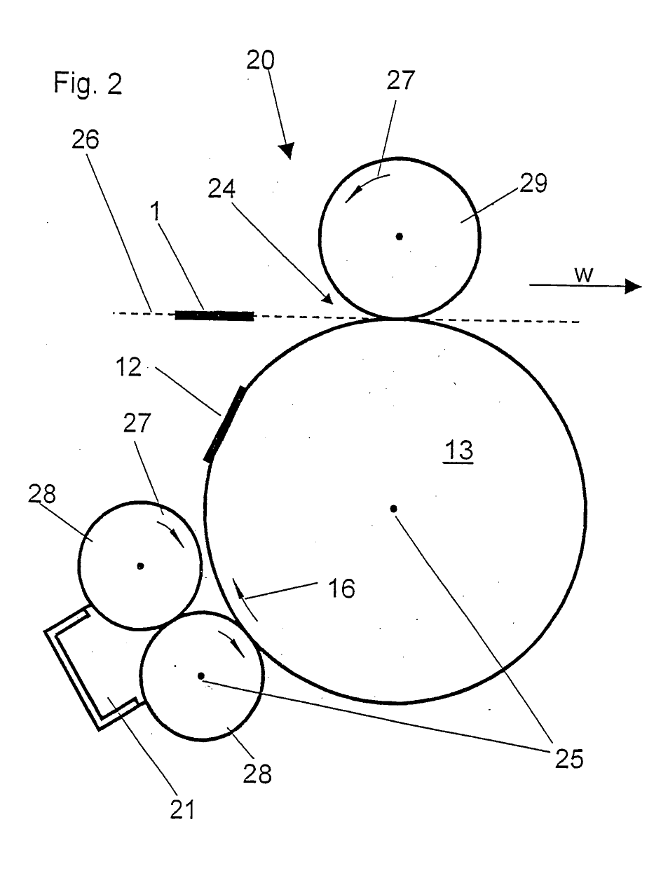

FIG. 2 a glue application apparatus for block bottom bags according to the prior art;

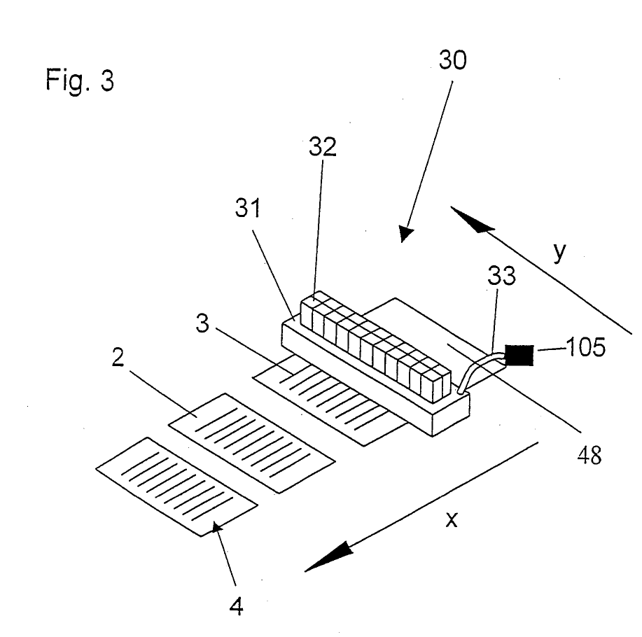

FIG. 3 view of an inventive device;

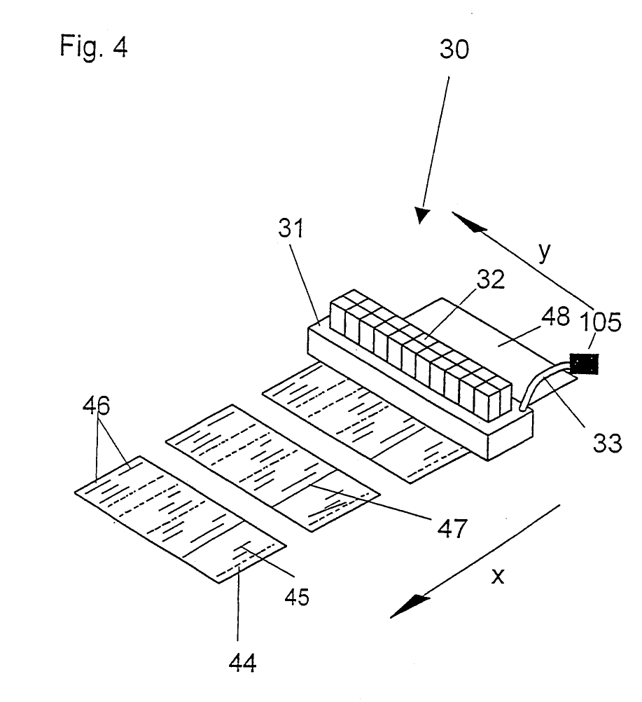

FIG. 4 View of an inventive device which generates complex glue formats.

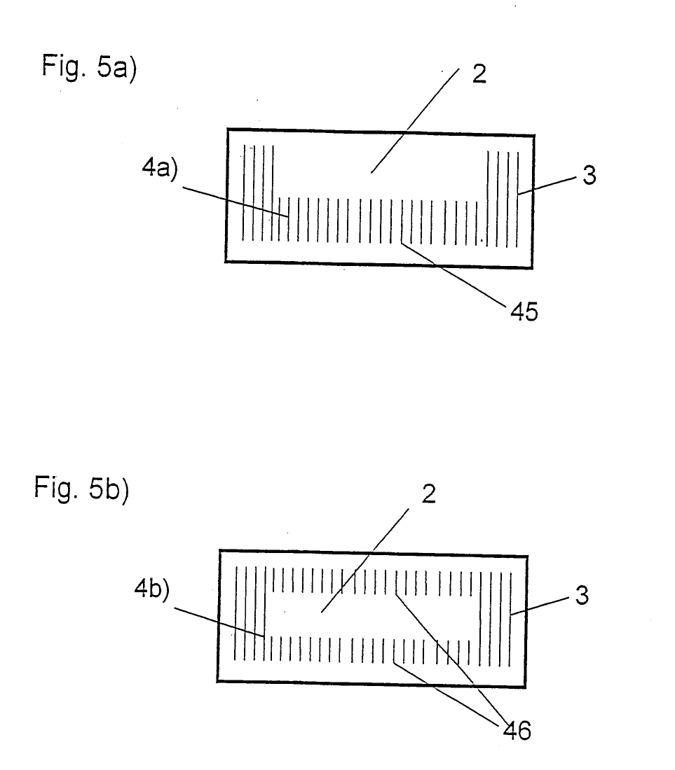

FIG. 5 a) A sheet 2 with a u-shaped glue format

FIG. 5 b) a sheet 2 with a glue format in the shape of a rectangular frame

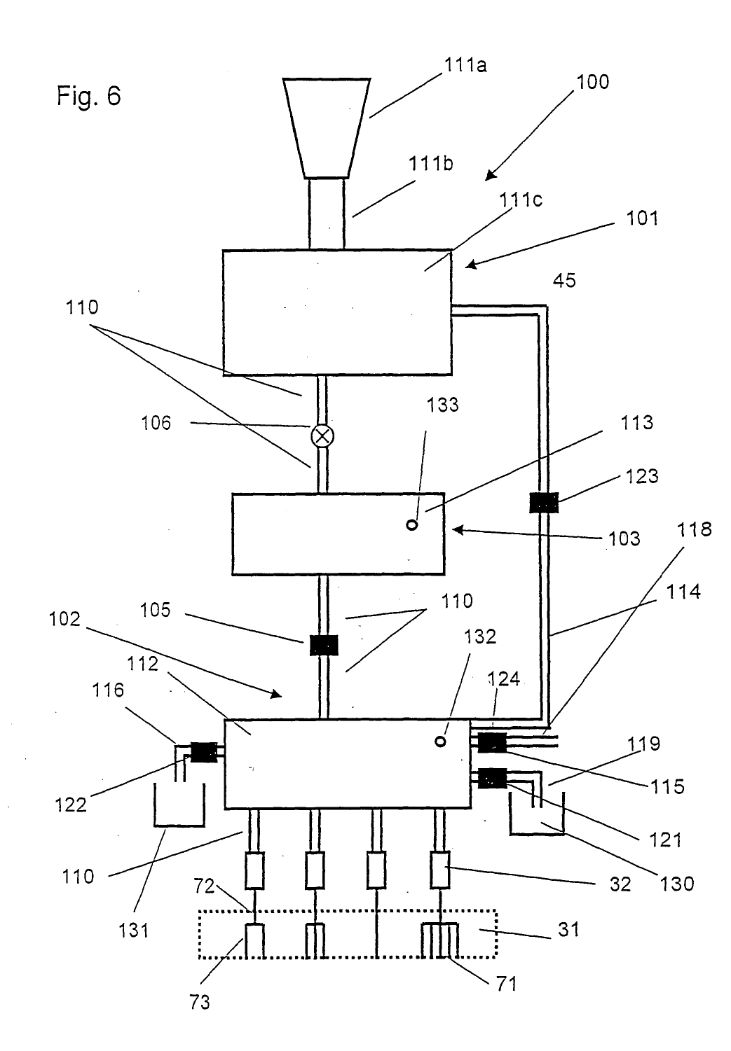

FIG. 6 schematic structure of an inventive apparatus

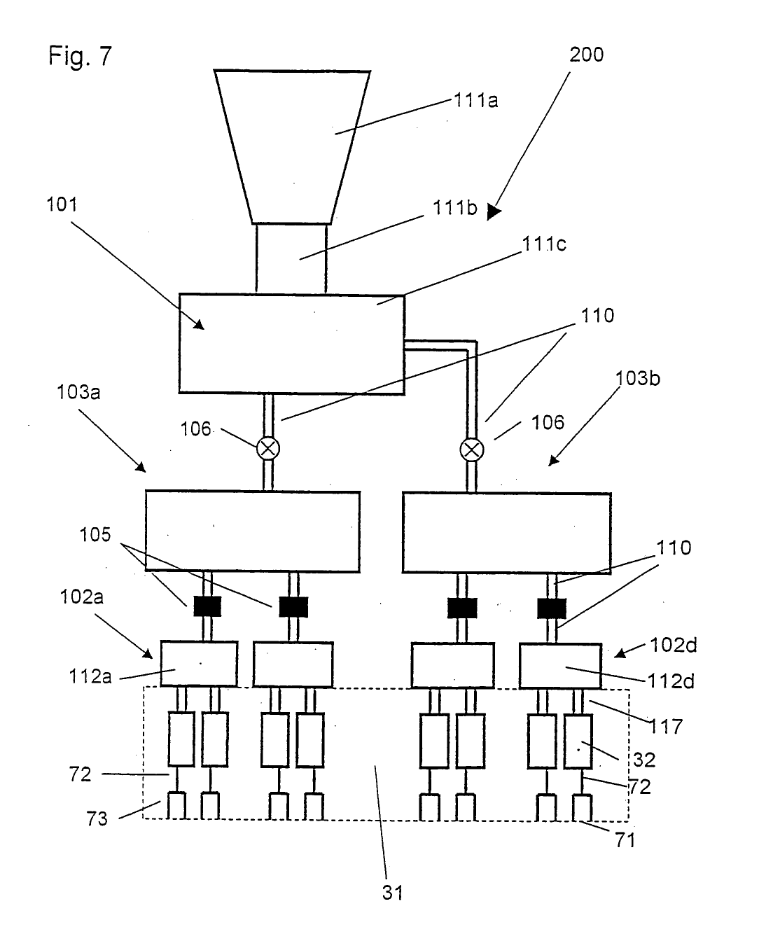

FIG. 7 schematic structure of another inventive apparatus

The figures below represent inventive glue application apparatuses for block bottom bags and apparatuses of the prior art. The inventive apparatuses that are represented glue only bottom sheets 2. But they could glue block bottoms 1 equally well.

FIG. 1 represents a glue application apparatus as it is typically employed in the prior art for gluing bottom sheets 2. In this apparatus, glue is transferred from a glue cylinder 11 onto the blank or stereotype 12, which is borne by a stereotype cylinder 13 and moved about the axis of the stereotype cylinder 13 in the direction of arrow 16. In this rotating movement, the stereotype or blank 12 transfers glue onto the bottom sheets 2, which are borne by the clamping cylinder 14 during the glue transfer process. Before that, the bottom sheets 2 are conveyed along the dotted line 18 in the direction of arrow x into the nip between the cylinders 13 and 14 by a transport device which is not represented. The rotation of the clamping cylinder 14 in the direction of arrow 15 conveys the glued sheets further to the bag bottoms 1, which are transported in the direction of arrow w by a transport device that is not represented. The bags 19 are terminated by the bag bottoms 1. Between the clamping cylinder 14 and the transport means for the bags, a pressure is built, which presses sheets 2 and bag bottoms together, thereby joining them permanently.

FIG. 2 represents another glue application apparatus 20 according to the prior art which is typically employed for gluing bag bottoms 1. To that end, a stereotype or blank 12, which is usually attached to the periphery of the stereotype cylinder 13, is brought into contact with the glue transfer cylinders 28 through the rotation of the stereotype cylinder 13 about its axis 25 in the direction of arrow 16, and is thus charged with glue. To that end, the blank has depressions which are not represented, which are filled with glue during contact with the glue transfer drums 28.

On their part, the glue transfer drums 28 limit the opening of a glue reservoir 21 and transport glue from the glue reservoir 21 to the stereotype 12 on their perimeter during rotation.

Further ahead in the course of rotation of cylinder 13, the stereotype or blank 12 reaches the nip 24 between the cylinders 29 and 13. There, the stereotype 12 transfers glue onto a bag bottom 1. The bag was previously transported along the dotted line 26 into the nip by a conveyor device that is not represented.

Given a change of bag formats, the blanks 12 of the glue stations 10 and 20 represented in the FIGS. 1 and 2 are replaced with blanks tailored to the new bag format.

FIG. 3 represents a sketch of a sheet gluing station 30 of an inventive block bottom laying machine which provides sheets 2, already singled and being conveyed in the direction of arrow x, with glue trails 3. To that end, the gluing station 30 is equipped with an application head 31. This application head is provided with glue by means of the tube 33. Inside the application head 31, the glue is distributed by suitable glue lines to the valves 32, which are attached to the application head 31 in two rows that run transverse to the transport direction x of sheets 2. These valves 32 are at least able to release or block the glue flow. They are drivable by means of external, preferably electrical, signals, and they 32 [sic] withstand the glue pressure.

Located on the bottom of the application head 31, which is not represented in FIG. 3, are glue outputs 71, through which the glue leaves the application head 31and forms the glue trails 3. Arrow x points in the transport direction of the sheets 2, whereas arrow y points in the horizontal direction running transverse thereto.

FIG. 4 represents a gluing station 30 which is apparently constructed exactly like the gluing station from FIG. 3. The different glue trails 44 to 47 show how the different glue formats can be realized with such a device, without the blanks having to be used. A variation of the stereotype width, i.e. the expanding of the glue area in direction y, can be realized by switching valves 32 on or off during the production of bags of this glue format. When so switched off, the valves are inactive for the entire duration of the gluing of sheets 2 or bag bottoms of a format. That way, rectangular glue formats as represented in FIG. 3 emerge, which are formed from continuous glue trails 3, 47 that are usually the same length.

But to accomplish this, the valves, which are active during the production of a glue format, must be closed after the production of a continuous glue trail 47 and re-opened with the arrival of the next as yet unglued sheet 48 at the glue outputs. Already this work sequence, at normal gluing rates, leads to substantial demands on the switching time of the valves 32. If further variations of the form of the glue format or the glue quantity are performed, the valves 32 must be able to be opened or closed even faster than in the production of continuous glue trails 47.

A substantial variation of the amount of glue applied is possible particularly by applying multiple interrupted glue trails 44. The further variation of the form of the glue format—including substantial deviations from a rectangular shape—requires the application of short 45 and interrupted glue trails 46. Frequently, the glue formats 4 are required to take the shape of a u 4a) or a rectangular frame 4b), as represented in FIGS. 5a) and b). To that end, the valves must be driven differently during the gluing of a bag component 1, 2.

It is advantageous when the valves 32 that are provided in the bottom laying machine have a switching time—that is to say, are switched in a time-span—which is shorter than 5 ms. A majority of the variations of glue formats needed in the industry that can be performed by modifying the individual glue trail lengths in direction x can then be realized at fast gluing rates in the manner described above.

The different glue trails 45 to 48 give some idea of how flexibly such an inventive apparatus can generate formats when the valves are switched even faster.

The embodiments of the invention represented in FIGS. 3 and 4 are just as suited to the actual gluing of sheets that have already been singled as they are to the gluing of paper webs which can be singled later. The gluing can be performed analogously on bag bottoms as well.

In the exemplifying embodiment represented in FIGS. 3 and 4, the second pressure reservoir 102 comprises the glue lines in the interior of the application head 31, which are not represented in FIGS. 3 and 4, as well as the tube 33. It terminates at the pressure regulator 105. It is advantageous when this pressure regulator or another valve that connects the second glue reservoir with a pressure reservoir also has an opening and closing time of shorter than 5 ms. If the pressure regulator is configured as a passive element, it must be able to respond within 5 ms.

As already mentioned, FIGS. 5a) and b) represent a u-shaped 4a) and a rectangular glue format 4b) on two sheets 2. The u-shaped glue format is composed of continuous 3 and short glue trails 45 [sic]. The glue format in the shape of a rectangular frame 4b) is composed of continuous 3 and interrupted glue trails 46. The different course of the glue trails is the result of a selective driving of the glue valves 32 during the gluing of a bag component 1, 2.

All exemplifying embodiments of the invention described in the subclaims and represented in the figures are suitable for direct as well as indirect gluing of bag components 1, 2 in which the glue is first transferred to a drum or other form before reaching the bag components.

FIG. 6 is a schematic representation of a complex inventive apparatus 100. The first glue reservoir 101 comprises the glue input funnel 111a via which glue is fed to the apparatus, the glue line 111b, the glue tank 111c, and the parts of the glue line 110 located upstream from the pump 106 in the direction of glue transport.

The pump 106 presses the glue into the third glue reservoir 103, which comprises the part of the glue line 110 following the pump 106, the glue tank 113, and the part of the glue line 110 between the glue tank 113 and the pressure regulator 105. The third glue reservoir 103 is under a higher pressure than the second 102. It thus serves as a pressure reservoir with respect to the second glue reservoir 102.

The pressure regulator 105 forwards glue from the third glue reservoir to the second. It can reduce the pressure to the pressure prevailing in the second glue reservoir 102. Like the two other glue reservoirs, the second glue reservoir 102 also comprises all parts of glue lines 110, 114, 115, 116, 117, 118, which are positioned upstream from the respective blocking valves and are therefore under the same pressure as glue tank 112.

In the operation of the inventive apparatus 100, the glue flows through the glue tank 112 —which can have a very small volume in the present embodiment of the invention—and reaches the valves 32. These are opened or closed according to the glue format to be formed and pass the glue to the upper glue channels 72. A part of these upper glue channels 72 branches again in the application head 31 into the lower glue channels 73, which opens into the glue outputs 71. In the gluing process, the glue exits the application head 31 via these glue outputs and is either directly or indirectly transferred to the bag components 1, 2.

The second glue reservoir 102 can be emptied another way, however. Glue can be let into the glue discharge container 131 via the glue discharge line 116 and the outlet valve 122. That way, a faster glue exchange and/or a fast depressurization can be performed. Cleaning media such as water or compressed air can be conducted over the cleaning medium line 118 for cleaning purposes. In particular, if liquid cleaning media are used, the utilization of collecting containers 130 for these media is recommended. The cleaning medium discharge 119 and the outlet valve 121 can be attached directly to the second glue reservoir.

A regular glue circulation between the first 101 and second glue reservoir 102 can be made possible by a glue drain 114. Here, the glue can advantageously pass through a pressure reducer/valve 123.

There remains the pressure measuring devices 132, 133, which permit the measuring of the pressure directly at the second and third glue reservoir. These pressure meters can be necessary for the purpose of monitoring the correct gluing. Allow even a real controlling of the amount of glue applied and other process parameters [sic].

FIG. 7 represents another embodiment of the invention 200. This embodiment also comprises the three glue reservoirs 101, 102, 103, whereby the third glue reservoir 103 simultaneously serves as pressure reservoir for the second glue reservoir. Unlike the embodiment represented in FIG. 6, the second and third glue reservoirs 102, 103 break down into subreservoirs 102a-dand 103a,b. The subreservoirs 102a-d are equipped with gas cushions, which are not represented but which are located inside the glue tanks 112a-d. These gas cushions serve as additional pressure reservoirs for the second glue reservoirs 102a-d. Another difference compared to exemplifying embodiment 100 consists in the glue lines 117, which—as already described in connection with FIGS. 3 and 4—extend inside the application head 31. In such an exemplifying embodiment, a majority or even the whole volume of the second glue reservoir 102 can be made available by such glue lines 117 and/or glue tubes 33.

Furthermore, it is advantageous when the glue is conducted over an uninterrupted glue line 101, 102, 103, 105, 106, 110 from a glue kitchen, in which starch glue is mixed together from its components and conditioned by stirring or rotating, to the second glue reservoir. In that case, the central glue kitchen of a bag production plant is the functional equivalent of a first part of the first glue reservoir 101. But is also possible to provide decentralized glue preparation stations, each of which is allocated to a respective inventive apparatus.

### Reference Characters

x sheet transport direction
y direction transverse to sheet transport (horizontal)
z direction transverse to sheet transport (vertical)
w direction of transport of bag bottoms 1
1 bag bottom
2 sheet
3 glue trail
4 rectangular glue format
4a) u-shaped glue format
4b) glue format in the shape of a rectangular frame
10 known gluing station, preferably for sheets
11 glue cylinder
12 stereotype or blank
13 stereotype cylinder
14 clamping cylinder
15 arrow in direction of rotation of clamping cylinder 14
16 arrow in direction of rotation of stereotype cylinder 13
17 arrow in direction of rotation of glue cylinder 17
18 dotted line
19 bag
21 glue reservoir
24 nip
25 axis of cylinders
26 dotted line sketched in the transport path of the bags
27 direction of cylinder rotation
28 glue transfer cylinder
29 impression cylinder
30 inventive gluing station
31 application head or plate
32 valves
32nvalve of the nth valve row
33 glue line/tube
44 interrupted glue trail at regular intervals
45 short glue trail
46 interrupted glue trail
47 continuous glue trail
48 unglued sheet
71 glue output
72 upper glue channel
73 lower glue channel
100 first inventive apparatus
101 1^{st} glue reservoir
102 2^{nd} glue reservoir
102a-d 2^{nd} lower reservoir
103 3^{rd} glue reservoir
103a-d 3^{rd} lower reservoir
105 pressure regulator
106 pump
110 glue lines
111a glue input funnel
111b glue line
111c 1^{st} glue tank
112 2^{nd} glue tank
112a-d glue tanks of the lower reservoirs 102a-d
113 3^{rd} glue tank
114 glue drain
115 input valve for cleaning media
116 glue discharge/depressurization
117 glue supply in the head
118 cleaning medium supply
119 cleaning medium discharge
121 discharge valve/cleaning medium
122 discharge valve for glue and depressurization
123 pressure reducer/valve at glue discharge 114
124 response valve for cleaning medium
130 discharge container for cleaning media
131 glue discharge container
132 pressure meter at 2^{nd} reservoir
133 pressure meter at 3^{rd} reservoir
200 second inventive apparatus

1: Apparatus (30, 100, 200) for forming a glue profile for gluing the bottom sheets (2) and/or folded bottoms (1) of tube portions which (1, 2) [sic] are used for forming block bottom bags (19), whereby the device (30,100,200) comprises the following features:
at least one first glue reservoir (101) or at least one glue input (111a,b) from which glue is supplied,
glue lines (110) which transport glue to the gluing locations,
a number of glue valves (32) which are to open and close individually, the glue profile (4) being definable based on the selective opening of the valves (32);
glue outputs (71) which are allocated to the valves (32);
at least one second glue reservoir (102), which communicates with at least two valves (32);
a pressure reservoir (103) by means of which the second glue reservoir (102) can be pressurized.

2: Apparatus according to claim 2, characterized in that the pressure reservoir (103) comprises a compressible medium—preferably a gas such as air—which is under pressure.

3: Apparatus according to claim 1 or 2, characterized in that the pressure reservoir (103) comprises at least a third glue reservoir (103), in which the glue is under a higher pressure than in the second reservoir (102).

4: Apparatus according to claim 3, characterized in that at least one third glue reservoir (103) is disposed between the first (101) and second (102) glue reservoir in the direction of glue transport.

5: Apparatus according to claim 4, characterized in that the at least one second glue reservoir and the at least one third glue reservoir are connected to one another by means of a pressure regulator (105).

6: Apparatus according to claim 5, characterized by a pressure regulator (105) which comprises a valve with which the connection between the second and third glue reservoirs can be opened and closed, whereby the opening time and closing time of the valve are each shorter than 5 ms.

7: Apparatus according to claim 4, characterized in that at least one pump (106) is provided between the first (101) and third glue reservoir (103), which pressures the glue into the third glue reservoir (103).

8: Apparatus according to claim 4, characterized in that the third glue reservoir (103) also communicates with a pressure reservoir.

9: Apparatus according to claim 3, characterized in that the at least one third glue reservoir comprises several glue pressure levels connected in series.

10: Apparatus according to claim 1, characterized by
at least one depressurization valve (122),
which is in direct contact with the second glue reservoir (102) and with which the pressure in the at least one second glue reservoir (102) can be reduced.

11: Apparatus according to claim 10, characterized in that the at least one second glue reservoir can be depressurized to atmospheric pressure by means of the at least one depressurization valve (122).

12: Apparatus according to claim 1, characterized in that besides the glue supply system (101, 102, 103, 105, 106, 110) which conducts glue in the direction of the valves (43), a glue discharge system (114) is also provided, which allows the discharge of glue by the valves (32) without the glue passing through the valves (32).

13: Apparatus according to claim 12, characterized in that a glue circulation and/or glue exchange in the apparatus (100, 200) can be performed by the interaction of the glue supply system (101, 102, 103, 105, 106, 110) and the glue discharge system (114).

14: Apparatus according to claim 3, characterized in that a pressure meter (132, 133) is provided at least at one of the following locations:
at the second glue reservoir (102),
at the third glue reservoir (103).

15: Apparatus according to claim 2, characterized in that the at least one second glue reservoir is provided with an additional supply and/or drain (119) through which a cleaning medium like water or compressed air can be conducted.

16: Apparatus according to claim 8, characterized in that glue (131) and/or water vessels (130) are provided, in which exchanged glue or used water which is discharged from the glue supply system can be collected.

17: Apparatus according to claim 1, characterized in that the at least one first glue reservoir (101) or the at least one glue input (111a,b) from which glue is supplied comprises a glue agitator in which components of starch glue—such as starch and water—can be placed and stirred into starch glue.

18: Method for forming a glue profile for gluing the bottom sheets (2) and/or folded bottoms (1) of tube portions which (1,2) are used for forming block bottom bags (19), comprising the following features:
glue is supplied to a glue transport system (101, 102, 103, 110, 111) via at least one first glue reservoir (101) or at least one glue input (111a,b),
glue is transported in the [sic] (101,102,103,110,111) to the gluing locations by glue lines (110),
valves (32) are driven which extrude the glue onto the bag components (1,2) through assigned glue outputs (71),
whereby the driving is selective, so that a glue profile (4) is defined,
whereby the glue, in passing through the glue transport system, first passes a third glue reservoir (103) and then a second (102), whereby the second glue reservoir (102) communicates with at least two valves (32),
whereby the pressure in the third glue reservoir (103) is higher than in the second (102).

19: Method according to claim 18, characterized in that the at least one valve (105) that connects the second glue reservoir (102) with the third glue reservoir is opened and closed with the same frequency with which the bag components pass the gluing station (30, 100, 200).
